(19) United States
(12) Patent Application Publication
(10) Pub. No.: US 2006/0052052 A1
(43) Pub. Date: Mar. 9, 2006

(54) Apparatus and method for receiving digital multimedia broadcasting signals

(75) Inventors: Suk-Jin Jung, Yongin-si (KR); Kyung-Ho Kim, Seongnam-Si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/219,954

(22) Filed: Sep. 6, 2005

(30) Foreign Application Priority Data
Sep. 6, 2004 (KR) 10-2004-0070711

(51) Int. Cl. H04H 1/00

(52) U.S. Cl. 455/3.01; 455/3.02

(57) ABSTRACT

An apparatus and method for receiving a multimedia broadcasting service in a mobile communication system including a satellite digital multimedia broadcasting (DMB) reception system and a terrestrial DMB reception system. In the apparatus, a satellite DMB modem block demodulates a satellite broadcast signal received from the satellite DMB system. A terrestrial DMB modem block, sharing at least one function block with the satellite DMB modem block, demodulates a terrestrial broadcast signal received from the terrestrial DMB system. A Motion Picture Experts Group (MPEG) decoder separately decodes MPEG transport streams (TSs) for the satellite broadcast signal and the terrestrial broadcast signal.

### PRIORITY

This application claims priority under 35 U.S.C. § 119 to an application entitled “Apparatus and Method for Receiving Digital Multimedia Broadcasting Signals” filed in the Korean Intellectual Property Office on Sep. 6, 2004 and assigned Serial No. 2004-70711, the contents of which are incorporated herein by reference.

### BACKGROUND OF THE INVENTION

1. Field of the Invention

The present invention relates generally to a broadcasting reception apparatus and method in a mobile communication system, and in particular, to a Digital Multimedia Broadcasting (DMB) reception apparatus and method capable of receiving both satellite broadcast signals and terrestrial broadcast signals, transmitted through a digital broadcasting system.

2. Description of the Related Art

In general, mobile terminals are mobile communication devices that can be carried by individuals for performing voice communications regardless of time and location. Moreover, with recent developments of mobile communication technologies, mobile terminals have begun to serve as information terminals capable of transmitting/receiving voice data and/or packet data. Mobile terminals capable of serving as information terminals include mobile phones, Work Analysis Program (WAP) phones, Personal Digital Assistants (PDAs), and a Web Pads. Improvements of mobile terminals in terms of mobility and personal service have resulted in an increase in number of the mobile terminals users.

The rapid progress of multimedia technologies has enabled additional services in which mobile terminals can transmit and/or receive high-quality still and/or moving image data in addition to voice data. Recently, attention has been directed to additional services provided by service providers. These additional services include broadcasting services in which the user can receive moving picture information such as movies, news, sports, stocks and weather. Moreover, attention has also been directed to call success rate and call quality of mobile terminals.

Broadcasting services are classified into analog broadcasting services and digital broadcasting services. Compared with conventional analog broadcasting services, digital broadcasting services can provide users with an advanced, high-image quality, high-voice quality services. In order to provide high-image quality, high-voice quality services, the digital broadcasting services compress broadcast traffic at a high compression rate before transmission, using a Motion Picture Experts Group-2 (MPEG-2) scheme or a Motion Picture Experts Group-4 (MPEG-4) scheme.

Digital broadcasting services use a high compression rate because of the requisite amount of data information. Currently, a digital multimedia broadcast (DMB) service is the most common type of digital broadcasting service.

The DMB service can broadcast various multimedia signals such as audio and video signals on a digital basis. For example, the DMB service can extend the concept of radio broadcasting from voice-only (e.g., audio) broadcasting to multimedia (e.g. audio and video) broadcasting, and can transmit various multimedia information such as traffic information, news information, etc., in textual, graphical and real-time moving image form in addition to the audio broadcasting. Further, the DMB service can link moving image broadcasting to the existing digital broadcasting networks such as terrestrial broadcasting, satellite broadcasting and cable TV, to provide various multimedia services. In addition, the DMB service can interwork with Intelligent Transportation System (ITS) and Global Positioning System (GPS), to provide a telematics service.

In particular, because the DMB service provides high-image quality, high-voice quality broadcasting not only to fixed terminals but also to mobile terminals such as mobile phones, PDAs and in-vehicle terminals, it is envisioned that the use of the DMB service will dramatically increase. The DMB service can be classified into terrestrial DMB service and satellite DMB service. The terrestrial DMB service refers to technology of providing a broadcasting service via a terrestrial repeater, also known as a gap filler. The satellite DMB service refers to technology of providing a broadcasting service via the terrestrial repeater and/or a satellite repeater.

A brief description will now be made of a broadcasting system that provides both the satellite DMB service and the terrestrial DMB service.

FIG. 1 is a block diagram illustrating a configuration of a system for providing a general satellite DMB service.

Referring to FIG. 1, a satellite DMB broadcasting center 100 on the ground transmits broadcast signals to a DMB satellite 106 through a Ku-band of 12 GHz through 13 GHz using Time Division Multiplexing (TDM) signals 102 or Code Division Multiplexing (CDM) 104 signals. Then the DMB satellite 106 receives the broadcast signals 102 and 104, and transmits the received broadcast signals 102 and 104 to mobile terminals 116 on the ground either directly or by using a gap filler 108 or a terrestrial repeater (not shown).

The DMB satellite 106 converts the broadcast signals 102 and 104 received from the satellite DMB broadcasting center 100 into an S-band (2 GHz through 3 GHz) CDM signal 112 and a Ku-band TDM signal 110. The S-band CDM signal 112 is transmitted directly to the mobile terminals 116 and the Ku-band TDM signal 110 is transmitted to the gap filler 108. The DMB satellite 106 transmits the broadcast signal to the gap filler 108 in order to provide the broadcast signals transmitted by the DMB satellite 106 to unserviceable areas, (i.e., areas in which satellite broadcast signals are insufficient for reception), which are also known as the “gap”, and can typically include areas such as basements, tunnels and other areas in which a satellite signal is not provided, or is attenuated, polluted by noise, reflected, etc. The gap filler 108 converts the received broadcast signals into S-band signals 114 and transmits the S-band signals 114 to the mobile terminals 116 in the unserviceable area.

In contrast with a satellite DMB broadcasting system, a terrestrial DMB system uses a broadcasting transmission tower (not shown) for transmission of terrestrial broadcasting, instead of using a DMB satellite transmitter (as is used in the satellite DMB system), transmitting broadcast signals to mobile terminals, and uses a gap filler, of an individual service provider, for providing service to an unserviceable area. The digital terrestrial DMB system is based on the European Digital Audio Broadcasting (DAB) system. Herein, the term “digital broadcasting system” refers to both the satellite DMB system and the terrestrial DMB system.

The terrestrial DMB system uses Orthogonal Frequency Division Multiplexing (OFDM) transmission scheme, and configures a single frequency network (SFN) using a plurality of broadcasting transmitters. In the SFN transmitters synchronously transmit the same data signals using the same frequency. Because the broadcast signals transmitted by the transmitters,, the signals do not serve as interference components to each other and provide a multipath channel effect. The multipath channel effect improves the quality of reception signals at a receiving mobile terminal.

DMB reception apparatuses for mobile terminals in the general satellite DMB system and terrestrial DMB system will now be described with reference to FIGS. 2 and 3, respectively.

FIG. 2 is a block diagram illustrating a structure of a general satellite DMB reception apparatus.

The satellite DMB system is provided such that it generally requires a channel for transmission of Conditional Access System (CAS) information, a channel for transmission of Electronic Program Guide (EPG) information, a channel for transmission of broadcast traffic and a channel for transmission of pilot information. Conventionally, broadcast traffic is transmitted over two channels. Therefore, as illustrated in FIG. 2, a bit deinterleaver 220, a convolutional decoder 230, a byte deinterleaver 240 and a Reed-Solomon (R-S) decoder 250 must be provided for each channel path.

The DMB reception apparatus for receiving satellite DMB service, as illustrated in FIG. 2, receives a satellite broadcast signal transmitted from the DMB satellite 106 or the gap filler 108 (i.e., a satellite repeater) at a CDM demodulator 210. The CDM demodulator 210 demodulates (despreads) the received satellite broadcast signal using a Walsh code for a corresponding reception channel, and outputs the demodulated satellite broadcast signal to the bit deinterleaver 220. To be specific, the outputs of the CDM demodulator 210 are separately provided to the bit deinterleavers 220 according to Walsh codes for reception channels. The bit deinterleaver 220 deinterleaves the received satellite broadcast signal bit-by-bit in order to disperse a possible per-bit burst error.

The deinterleaved satellite broadcast signal is input to the convolutional decoder 230. The convolutional decoder 230 performs error correction on the convolutional-coded signal output from the bit deinterleaver 220, and outputs the error-corrected satellite broadcast signal to the byte deinterleaver 240. The byte deinterleaver 240 deinterleaves the satellite broadcast signal output from the convolutional decoder 230 byte-by-byte in order to disperse a possible per-byte burst error. That is, the byte deinterleaver 240 corrects a burst error which occurs when the convolutional decoder 230 fails to perform adequate error correction.

The satellite broadcast signal output from the byte deinterleaver 240 is input to the R-S decoder 250. The R-S decoder 250 corrects an error signal in the received deinterleaved signal using parity data, and outputs the error-corrected signal to a CAS 260. The CAS 260 performs reception authentication on a CAS channel signal received from the R-S decoder 250. After the satellite broadcast signal undergoes reception authentication by the CAS 260, the satellite broadcast signal of the traffic channel is transmitted to an MPEG decoder 280 via an output interface 270. The MPEG decoder 280 decodes the satellite broadcast service signal and provides the decoded signal to the user.

With reference to FIG. 3, a description will now be made of a mobile terminal for receiving terrestrial DMB broadcast service.

FIG. 3 is a block diagram illustrating a structure of a general terrestrial DMB reception apparatus.

A mobile terminal for receiving terrestrial DMB broadcast service receives a terrestrial DMB-based radio signal (hereinafter referred to as a terrestrial broadcast signal) transmitted over the air via an antenna (not shown). The terrestrial broadcast signal is received in the form of an OFDM symbol, and input to an OFDM demodulator 311. The OFDM demodulator 311 removes a guard interval from the received OFDM symbol and performs fast Fourier transform (FFT) on the guard interval-removed OFDM symbol for demodulation. The demodulated terrestrial broadcast signal is input to a bit deinterleaver 312. The bit deinterleaver 312 deinterleaves the terrestrial broadcast signal received from the OFDM demodulator 311 bit-by-bit in order to disperse a possible per-bit burst error.

The deinterleaved terrestrial broadcast signal, which is a convolutional-coded signal, is input to a convolutional decoder 313. The convolutional decoder 313 performs error correction on the deinterleaved terrestrial broadcast signal received from the bit deinterleaver 312, and outputs the error-corrected terrestrial broadcast signal to a demultiplexer (DEMUX) 315. The demultiplexer 315 demultiplexes the error-corrected terrestrial broadcast signal received from the convolutional decoder 313 into audio/data information and an MPEG signal. The audio/data information is input to an audio/data decoder 321 via an output interface 320 and then is input into an audio/data decoder 321 which decodes a DAB-based terrestrial broadcast service signal and provides the decoded signal to the user.

The MPEG signal is input from the demultiplexer 315 to an MPEG transport stream (TS) synchronizer 314. The MPEG TS synchronizer 314 acquires synchronization by detecting predetermined code information “0x47” periodically included in header information of an MPEG TS. An output of the MPEG TS synchronizer 314 is input into a byte deinterleaver 316. The byte deinterleaver 316 deinterleaves the convolutional-decoded MPEG signal byte-by-byte, and outputs the deinterleaved MPEG signal to an R-S decoder 317. The R-S decoder 317 decodes an error signal in the deinterleaved MPEG signal using parity data, and outputs the decoded signal to an MPEG decoder 319 via an output interface 318. The MPEG decoder 319 decodes a terrestrial broadcast service signal from the MPEG signal and provides the decoded signal to the user.

As described above, the satellite DMB reception apparatus and the terrestrial DMB reception apparatus have different structures and receive broadcast signals according to their own standards. Therefore, in order to receive both satellite and terrestrial DMB service, conventional mobile terminals may require a terrestrial DMB reception apparatus and a satellite DMB reception apparatus, which the mobile terminal's hardware complexity. Alternatively, when a mobile terminal includes a satellite DMB reception apparatus and a terrestrial DMB reception apparatus that share the same functions to reduce the hardware complexity, the mobile terminal cannot receive a satellite broadcast signal and a terrestrial broadcast signal at the same time. Therefore, there is a need for a DMB reception apparatus capable of receiving a satellite broadcast signal and a terrestrial broadcast signal with low hardware complexity. Additionally, there is a need for a DMB reception apparatus with low hardware complexity which is capable of simultaneously receiving a satellite broadcast signal and a terrestrial broadcast signal.

### SUMMARY OF THE INVENTION

It is, therefore, an object of the present invention to provide a DMB reception apparatus and method capable of receiving both terrestrial broadcast signals and satellite broadcast signals in a digital broadcasting system.

It is another object of the present invention to provide a DMB reception apparatus and method for receiving both terrestrial broadcast signals and satellite broadcast signals with low hardware complexity in a digital broadcasting system.

According to one aspect of the present invention, there is provided an apparatus for receiving a multimedia broadcasting service in a mobile communication system in which a satellite digital multimedia broadcasting (DMB) system and a terrestrial DMB system coexist. The apparatus includes a satellite DMB modem block for demodulating a satellite broadcast signal received from the satellite DMB system, a terrestrial DMB modem block sharing at least one function block with the satellite DMB modem block, the terrestrial DMB modem block for demodulating a terrestrial broadcast signal received from the terrestrial DMB system, and a Motion Picture Experts Group (MPEG) decoder for separately decoding MPEG transport streams (TSs) for the satellite broadcast signal and the terrestrial broadcast signal.

According to another aspect of the present invention, there is provided a method for receiving a multimedia broadcasting service in a mobile communication system in which a satellite digital multimedia broadcasting (DMB) system and a terrestrial DMB system coexist. The method includes simultaneously receiving a satellite broadcast signal of the satellite DMB system and a terrestrial broadcast signal of the terrestrial DMB system, from a wireless network; modifying a header of a first Motion Picture Experts Group (MPEG) transport stream (TS) for the terrestrial broadcast signal with a predetermined value being different from that of a header of a second MPEG TS for the satellite broadcast signal, and separately MPEG-decoding the first MPEG TS for the terrestrial broadcast signal and the second MPEG TS for the satellite broadcast signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a configuration of a general satellite DMB system;

FIG. 2 is a block diagram illustrating a structure of a general satellite DMB reception service;

FIG. 3 is a block diagram illustrating a structure of a general terrestrial DMB reception apparatus;

FIG. 4 is a block diagram illustrating a structure of a DMB reception apparatus according to an embodiment of the present invention;

FIG. 5 is a block diagram illustrating a structure of a DMB reception apparatus according to another embodiment of the present invention;

FIG. 6 is a block diagram illustrating a structure of a DMB reception apparatus according to further another embodiment of the present invention;

FIGS. 7A and 7B are flowcharts illustrating a terrestrial DMB reception process in a simultaneous reception mode according to an embodiment of the present invention; and

FIG. 8 is a flowchart illustrating a process of replacing a reception channel for satellite broadcast signals with a spare channel according to an embodiment of the present invention.

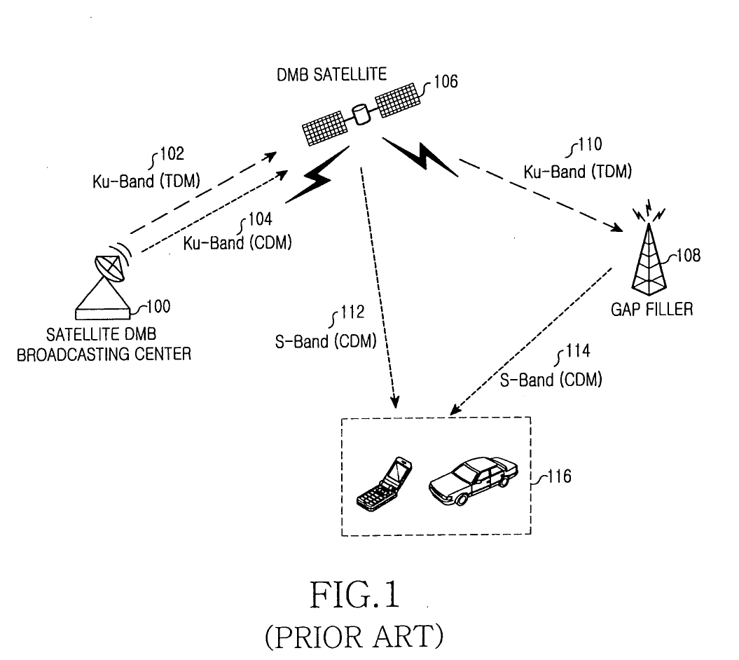

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

The present invention will be described herein below with reference to the following three embodiments.

A first embodiment simultaneously receives satellite broadcast signals and terrestrial broadcast signals using a single DMB reception apparatus, wherein the DMB reception apparatus receives the satellite broadcast signals using a satellite DMB modem and receives the terrestrial broadcast signals using spare channels in the satellite DMB modem. A second embodiment increases the number of channels available for reception of the terrestrial broadcast signals. A third embodiment receives the terrestrial broadcast signals using a predetermined channel in the satellite DMB modem, wherein when the satellite DMB modem desires to use the particular channel to receive satellite broadcast signals, the satellite DMB modem receives the corresponding satellite broadcast signals using spare channels.

With reference to the accompanying drawings, a detailed description will now be made of the embodiments of the present invention.

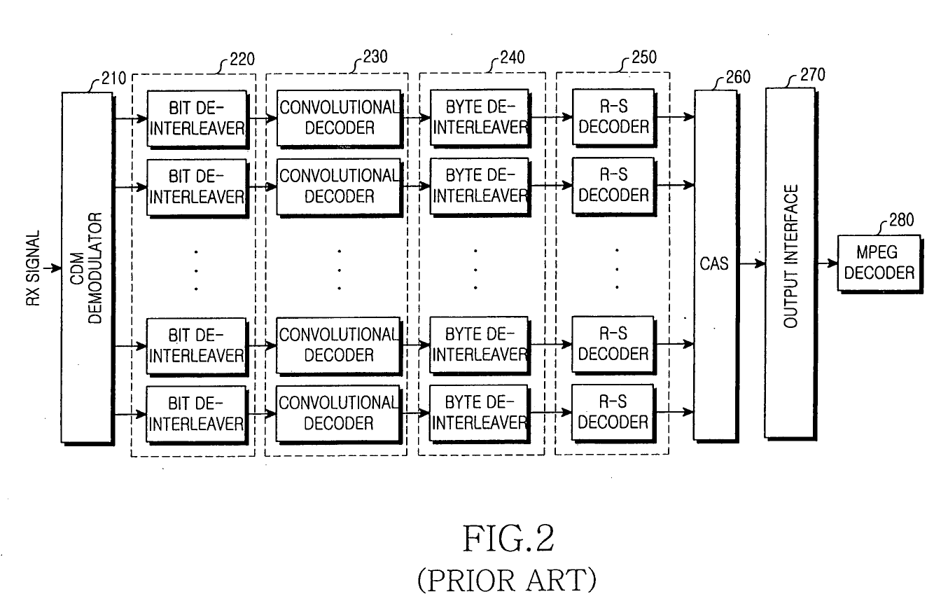

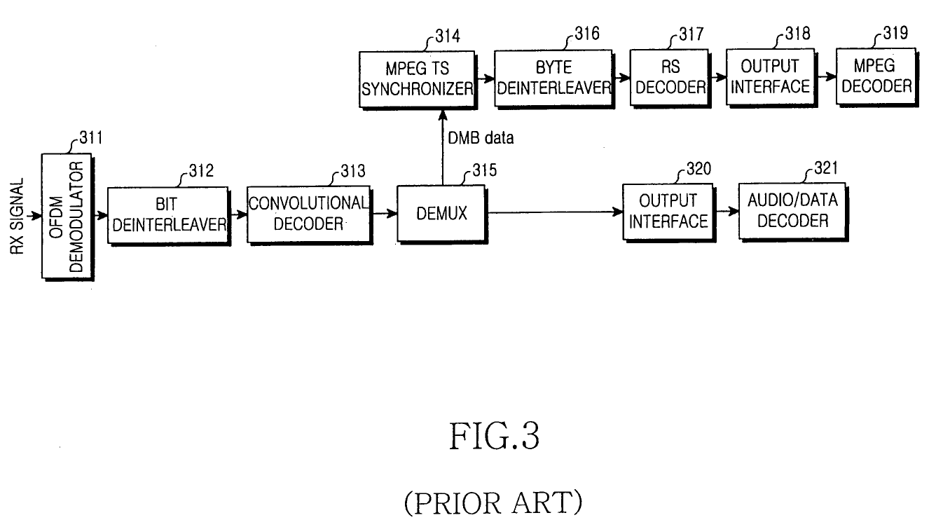

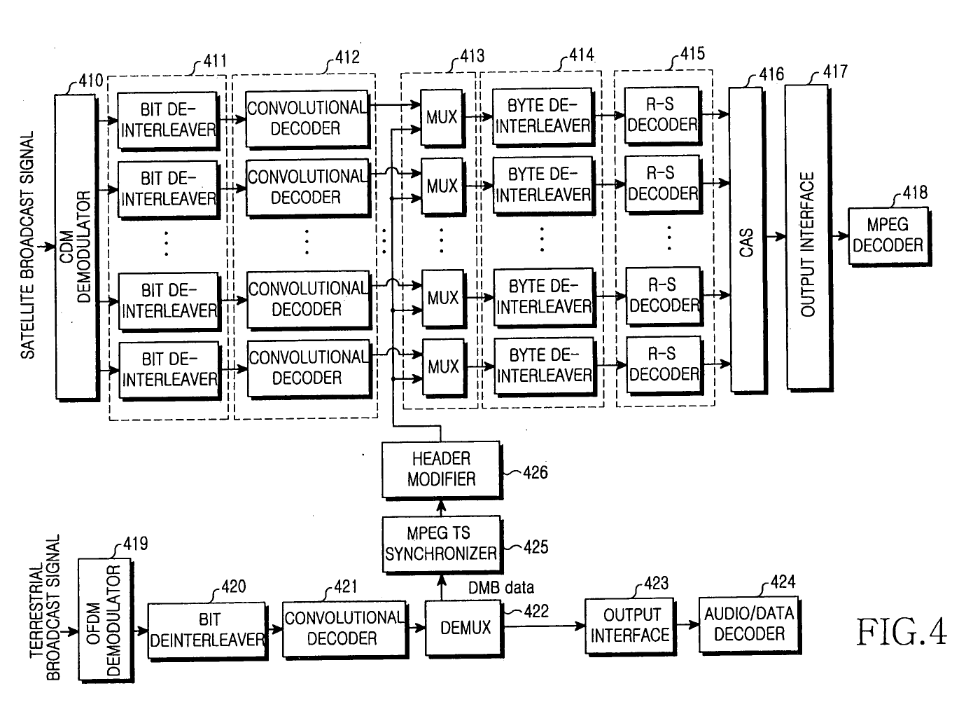

FIG. 4 is a block diagram illustrating a structure of a DMB reception apparatus according to an embodiment of the present invention. A detailed description of the elements being identical in structure to those in FIGS. 2 and 3 will be omitted herein for the sake of clarity.

In FIG. 4, a satellite DMB modem block for receiving satellite broadcast signals includes a plurality of channels for receiving Conditional Access System (CAS) information, Electronic Program Guide (EPG) information, broadcast traffic, and pilot information, etc. Herein, the channels for receiving the broadcast traffic include at least two channels for receiving at least one satellite broadcast signal, and at least one channel for receiving at least one terrestrial broadcast signal. Therefore, as illustrated in FIG. 4, bit deinterleavers 411, convolutional decoders 412, multiplexers 413, byte deinterleavers 414 and R-S decoders 415 included in the satellite DMB modem block are equal in number to required channels.

Referring to FIG. 4, the DMB reception apparatus is designed such that the bit deinterleavers 411 and the convolutional decoders 412 of the satellite DMB modem block and a bit deinterleaver 420 and a convolutional decoder 421 of a terrestrial DMB modem block, respectively, are separate units the byte deinterleavers 414 and the R-S decoders 415 of the satellite DMB modem block are shared with the terrestrial DMB modem block. This is because the bit deinterleavers 411 and 420 and the convolutional decoders 412 and 421 use different signal processing methods for processing the satellite DMB signals and the terrestrial DMB signals while the byte deinterleavers 414 and the RS-decoders 415 are used for receiving both the satellite DMB scheme and the terrestrial DMB signals because signal processing required by these units to receive both the satellite DMB signals and the terrestrial DMB signals is identical. Therefore, the present invention can simplify the DMB reception apparatus capable of simultaneously receiving the satellite DMB service and the terrestrial DMB servicesharing components which have identical functions in both the satellite DMB modem block and the terrestrial DMB modem block.

In addition, the present invention interposes the multiplexers 413 between the convolutional decoders 412 of the satellite DMB modem block and the byte deinterleavers 414 so that the DMB reception apparatus can simultaneously receive the satellite broadcast signals and the terrestrial broadcast signals. Although the multiplexers 413 are equal in number to the channels of the satellite DMB modem in FIG. 4, the DMB reception apparatus can also be designed such that at least one multiplexer is arranged in a particular channel path for which a spare channel can be allocated.

Preferably, the present invention arranges the multiplexers 413 in the front of the byte deinterleavers 414 to simplify the DMB reception apparatus. However, if the terrestrial DMB modem block does not share the byte deinterleavers 414 or all of the byte deinterleavers 414 and the R-S decoders 415 with the satellite DMB modem block, the present invention can arrange the multiplexers 413 immediately before or after the R-S decoders 415.

In the structure of FIG. 4, acontroller (not shown) controls the multiplexers 413 to connect the terrestrial DMB modem block to the satellite DMB modem block such that the DMB reception apparatus receives the next terrestrial broadcast signals using spare channels of the satellite DMB modem block, after detecting setting of a predetermined mode for simultaneously receiving satellite broadcast signals and terrestrial broadcast signals. The setting of the simultaneous reception mode can be implemented with the well-known picture-in-picture (PIP) function of outputting a plurality of screens with a display (not shown). A detailed description of the PIP function will be omitted herein for the sake of clarity.

When the simultaneous reception mode is set, the terrestrial broadcast signals are input to all of the multiplexers 413, but a controller (not shown) selects the terrestrial broadcast signals output through the multiplexer 413 located in a path for the spare channel and blocks terrestrial broadcast signals output through the remaining multiplexers 413. That is, because the satellite DMB modem block performs channel decoding using a corresponding Walsh code, the controller determines a Walsh code used for reception of the satellite broadcast signals and its channel route using a CDM demodulator 410, and controls the multiplexers 413 to set a channel unused for reception of the satellite broadcast signals as a spare channel and receives the terrestrial broadcast signals using the spare channel.

However, if the broadcast signals of the two different types (i.e., the satellite broadcast and the terrestrial broadcast signals) are input to an MPEG decoder 418, the MPEG decoder 418 cannot distinguish between transport streams (TSs) of the two different types. This is because both of the satellite broadcast signals and the terrestrial broadcast signals are transmitted with MPEG TSs in which predetermined header information “0x47” (where “0x47” means a start code of a MPEG TS having a size of 188 bytes) is periodically included.

A description will now be made of a novel method for separately receiving an MPEG TS corresponding to the satellite broadcast signals and an MPEG TS corresponding to the terrestrial broadcast signals

A demultiplexer 422 of the terrestrial DMB modem block classifies a terrestrial broadcast signal received from the convolutional decoder 421 into audio/data and an MPEG signal. The audio/data is input to an audio/data decoder 424 via an output interface 423 according to conventional methods. The MPEG signal is input from the demultiplexer 422 to an MPEG TS synchronizer 425. The MPEG TS synchronizer 425 acquires synchronization by detecting periodic header information “0x47” of the MPEG TS. An output of the MPEG TS synchronizer 425 is delivered to a TS header modifier 426, and the TS header modifier 426 modifies an MPEG TS header in the terrestrial broadcast signals using a predetermined value.

Modifying the MPEG TS header using a predetermined value (e.g., “0x47”) which is different from a value for a MPEG TS header for a satellite service allows the signals to be distinguished from each other by the R-S decoders as will be described below means that in the terrestrial and satellite DMB services,

Terrestrial broadcast signals including the modified MPEG TS header value are input to the multiplexers 413. The controller (not shown) of the mobile terminal selects an output of a terrestrial broadcast signal by controlling the multiplexer 413 connected to a spare channel, blocks the terrestrial broadcast signals output through the remaining multiplexers 413 and outputs the satellite broadcast signals through the remaining multiplexer 413.

The byte deinterleavers 414 deinterleave MPEG TSs for the convolutional-decoded satellite broadcast signals and terrestrial broadcast signals byte-by-byte, and output the deinterleaved MPEG TSs to the R-S decoders 415. The R-S decoders 415 correct error signals in the deinterleaved MPEG TSs, and output the error-corrected MPEG TSs for both the satellite broadcast signals and the terrestrial broadcast signals to the MPEG decoder 418 via an output interface 417.

The R-S decoders 415 perform a 0x47-header calculation regardless of whether the MPEG TS headers include 0x47 or another pattern. The R-S decoders 415 can recognize MPEG TS headers for the terrestrial broadcast signals, modified with a pattern other than 0x47, as a defective header, and correct the defective header. Therefore, the R-S decoders 415 must be set such that when the terrestrial DMB signals and the satellite DMB signals are simultaneously received, the R-S decoders 415 should not correct the value modified by the TS header modifier 426. This is to maintain the error correction capability of the R-S decoders 415.

A CAS 416 performs reception authentication on CAS information, and delivers the MPEG TSs error-corrected through the R-S decoders 415 to the MPEG decoder 418, if the reception authentication is successful or a conditional access is not set. A conditional access function is used to control various access channels provided in the satellite DMB service and to prevent unauthorized channels from being displayed. In other words, the controlled access function prevents users from watching unauthorized channels (e.g., pay-per-view channels, etc.) which they have not subscribed to. The MPEG decoder 418 recognizes an MPEG TS starting with a different header pattern as a terrestrial broadcast signal and distinguishes the terrestrial broadcast signal from the satellite broadcast signal in the decoding process.

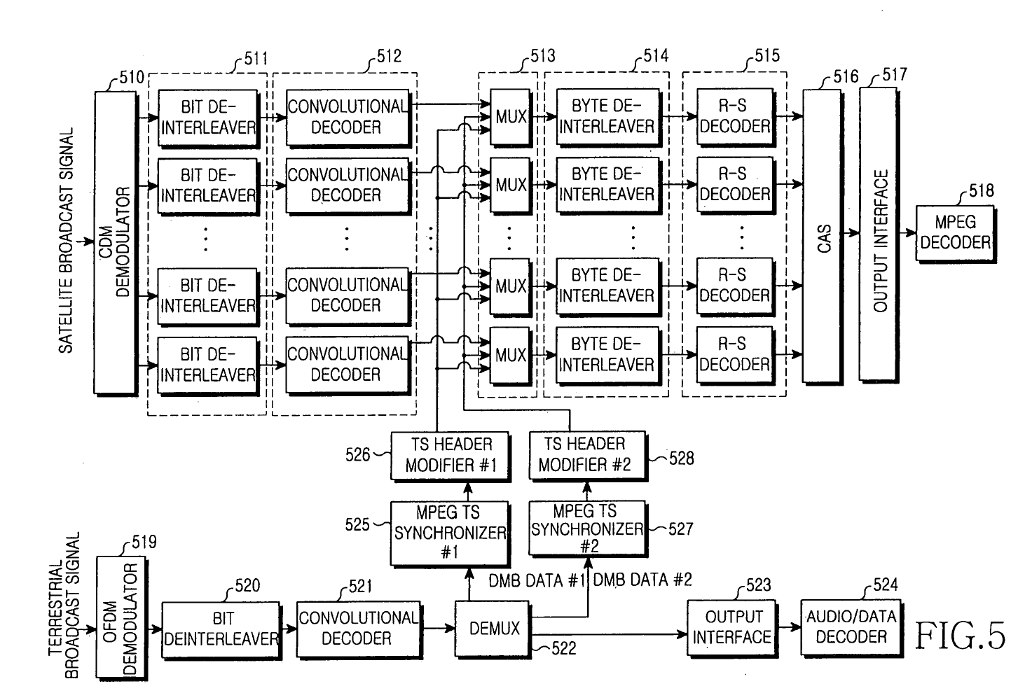

FIG. 5 is a block diagram illustrating a structure of a DMB reception apparatus according to another embodiment of the present invention, wherein the number of channels simultaneously available for reception of terrestrial broadcast signals is increased.

The terrestrial DMB service can transmit broadcast signals on a plurality of channels through one frequency band on a time division basis. If two terrestrial channels are simultaneously received, the DMB reception apparatus further includes MPEG TS synchronizers 525 and 527 and TS header modifiers 526 and 528 as illustrated in FIG. 5. The embodiment of FIG. 5, similarly to the embodiment shown in FIG. 4, receives terrestrial broadcast signals using spare channels in the satellite DMB modem block, and forms MPEG TSs having different header patterns for distinguishing broadcast signals at an MPEG decoder 518.

Both of the embodiments of FIGS. 4 and 5 are implemented such that byte deinterleavers 414 and 514 selectively receive either the satellite broadcast signals or the terrestrial broadcast signals through multiplexers 413 and 513, and receive the terrestrial broadcast signals using spare channels (i.e., channels unused for reception of 10 the satellite broadcast signals). Referring to FIG. 5, bit deinterleavers 511 and convolutional decoders 512 of a satellite DMB modem block and a bit deinterleaver 520 and a convolutional decoder 521 of a terrestrial DMB modem block are separately provided, and byte deinterleavers 514 and R-S decoders 515 of the satellite DMB modem block are shared with the terrestrial DMB modem block.

In the structure of FIG. 5, if terrestrial broadcast signals on two channels are simultaneously received, a demultiplexer 522 of the terrestrial DMB modem block classifies the terrestrial broadcast signals on the two channels received from the convolutional decoder 521 into audio/data and MPEG TSs. The demultiplexer 522 delivers a terrestrial broadcast signal (first DMB data) on one channel among the MPEG TSs to the first MPEG TS synchronizer 525, and delivers a terrestrial broadcast signal (second DMB data) on another channel to the second MPEG TS synchronizer 527.

The first and second MPEG TS synchronizers 525 and 527 acquire synchronization by detecting periodic header information ‘0x47’ from the MPEG TSs for the corresponding channels. The MPEG TS for the channel of which synchronization is detected through the first MPEG TS synchronizer 525 is delivered to the first TS header modifier 526 where its MPEG TS header is modified with a predetermined value other than 0x47. Similarly, an MPEG TS for another channel of which synchronization is detected through the second MPEG TS synchronizer 527 is delivered to the second TS header modifier 528 where its MPEG TS header is modified with a predetermined value.

The terrestrial broadcast signals on the two channels output from the first and second TS header modifiers 526 and 528 are applied to all of the multiplexers 513. A controller (not shown) selects outputs of the terrestrial broadcast signal on the two channels by controlling two multiplexers 513 connected to the spare channels, cuts off the terrestrial broadcast signals output through the remaining multiplexers 513, and outputs the satellite broadcast signals. The R-S decoders 515 perform 0x47-header calculation regardless of whether the MPEG TS headers include 0x47 or another pattern to correct errors in the MPEG TSs, and deliver the error-corrected MPEG TSs for the satellite broadcast signals and/or the terrestrial broadcast signals to the MPEG decoder 518 via a CAS 516 and an output interface 517.

The MPEG decoder 518 separately decodes the satellite broadcast signals and the terrestrial broadcast signals by analyzing headers of the received MPEG TSs.

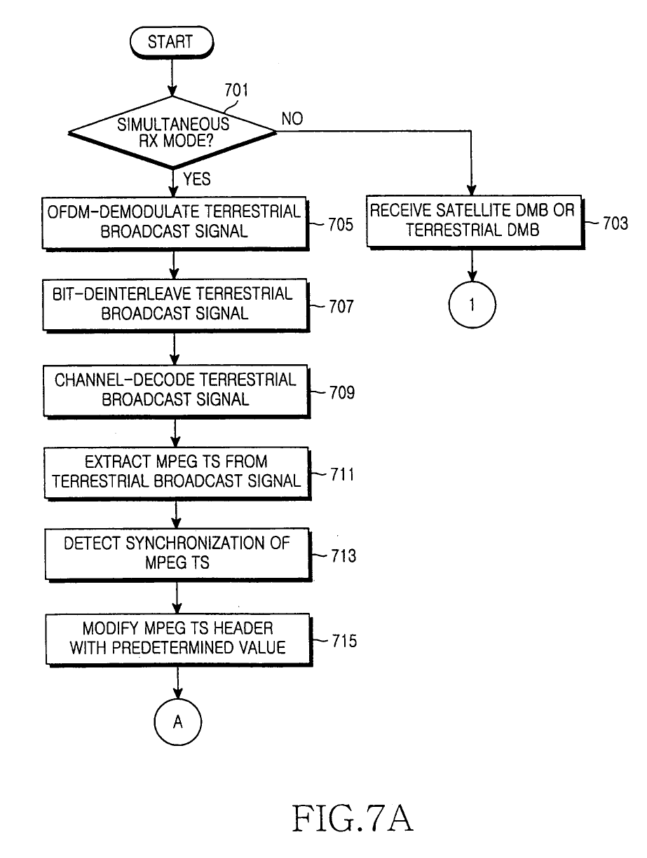

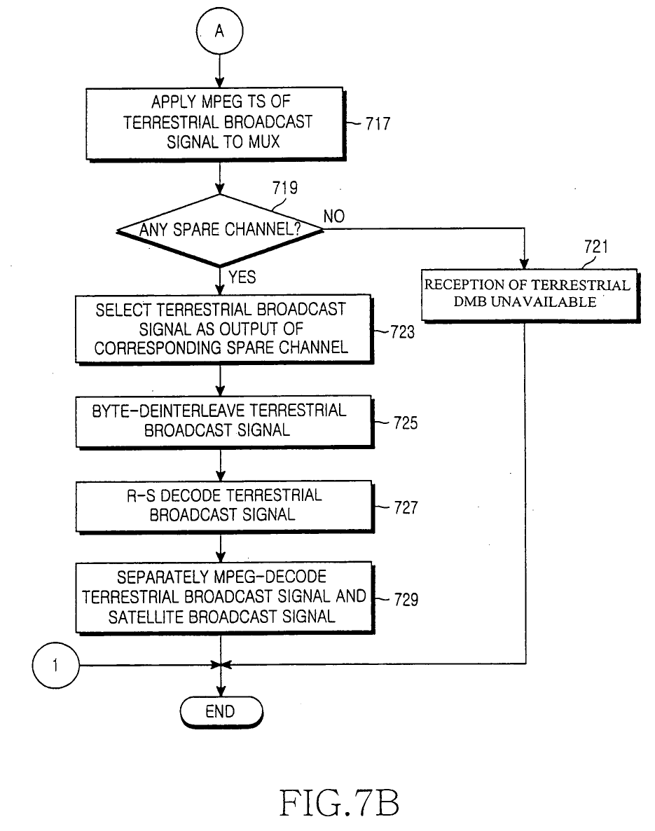

With reference to FIGS. 7A and 7B, a description will now be made of a novel DMB reception method using spare channels according to the embodiments of FIGS. 4 and 5. FIGS. 7A and 7B are flowcharts illustrating a detailed description of a terrestrial DMB reception process in a simultaneous reception mode. A satellite DMB reception process has been described above, so a detailed description thereof will be omitted herein for the sake of clarity.

In step 701, a controller (not shown) of a mobile terminal determines if a simultaneous reception mode for both a satellite DMB service and a terrestrial DMB service is set. Herein, the mobile terminal can selectively receive one of or simultaneously receive both of the satellite DMB service and the terrestrial DMB service because it includes a satellite DMB modem block for receiving satellite broadcast signals and a terrestrial DMB modem block for receiving terrestrial broadcast signals as illustrated in FIGS. 4 and 5. Setting of the simultaneous reception mode is performed by the controller, and it will be understood by those skilled in the art that a user interface for selecting a DMB reception mode can be simply provided to the structures of FIGS. 4 and 5.

Therefore, a user of the mobile terminal can select one of a satellite DMB reception mode, a terrestrial DMB reception mode and a simultaneous reception mode using a predetermined screen interface provided by the controller.

If it is determined in step 701 that the simultaneous reception mode is not set, the controller proceeds to step 703 where it receives satellite broadcast signals or terrestrial broadcast signals using the satellite DMB modem block or the terrestrial DMB model block according to a selected reception mode. In the terrestrial DMB reception mode, byte deinterleaving and R-S decoding in FIGS. 4 and 5 are performed using corresponding elements in the satellite DMB modem block.

However, if it is determined in step 701 that the simultaneous reception mode is set, an OFDM demodulator 419 or 519 removes a guard interval from terrestrial broadcast signals transmitted over an OFDM symbol, and perform an FFT process on the guard interval-removed terrestrial broadcast signals for demodulation in step 705. Thereafter, in step 707, a bit deinterleaver 420 or 520 deinterleaves the terrestrial broadcast signals received from the OFDM demodulator 419 or 519 bit-by-bit. In step 709, a convolutional decoder 421 or 521 convolutional-codes the deinterleaved terrestrial broadcast signals for error correction. In step 711, a demultiplexer 422 or 522 demultiplexes the error-corrected terrestrial broadcast signals received from the convolutional decoder 421 or 521 into audio/data and MPEG TS(s). The MPEG TS(s) is input from the demultiplexer 422 or 522 to the MPEG TS synchronizer(s).

The MPEG TS(s) is applied to a single MPEG TS synchronizer 425 in the case of FIG. 4 where one channel is received, and is applied to multiple MPEG TS synchronizers 525 and 527 in the case of FIG. 5 where multiple channels are received. In step 713, the MPEG TS synchronizer(s) 425 (or 525 and 527) acquires synchronization by detecting predetermined periodic code information “0x47” from a header of the MPEG TS. An output(s) of the MPEG TS synchronizer(s) 425 (or 525 and 527) is delivered to a TS header modifier(s) 426 (or 526 and 528).

In step 715, the TS header modifier(s) 426 (or 526 and 528) modifies a header of the MPEG TS with a predetermined value to distinguish between the terrestrial broadcast signals and the satellite broadcast signals. In step 717, the terrestrial broadcast signals including the modified MPEG TS header value are delivered to multiplexers 413 or 513 on all of the channel paths of the satellite DMB modem. In step 719, the controller determines if there one or more spare channel(s). If spare channels are unavailable, the controller proceeds to step 721 where it displays a message indicating the reception of the terrestrial DMB service on a display (not shown) is currently unavailable.

Alternatively, it is preferable that the spare channel detection process of step 719 can be performed along with the simultaneous reception mode setting process of step 701.

However, if it is determined in step 719 that there is a spare channel, the controller proceeds to step 723 where it selects an output of a terrestrial broadcast signal received through a spare channel path by controlling the multiplexers 413 or 513, cuts off terrestrial broadcast signals output through the remaining multiplexers 413 and 513, and outputs the terrestrial and satellite broadcast signals. Thereafter, in step 725, the byte deinterleavers 414 or 514 deinterleave the MPEG TSs for the terrestrial broadcast signals and the satellite broadcast signals received through their associated channel paths byte-by-byte.

In step 727, R-S decoders 415 or 515 perform a 0x47-header calculation regardless of whether the MPEG TS headers include “0x47” or another pattern to correct errors in the MPEG TSs, and deliver the error-corrected MPEG TSs to a MPEG decoder 418 or 518 via a CAS 416 or 516 and an output interface 417 or 517. In step 729, the MPEG decoder 418 or 518 separately decodes the satellite broadcast signals and the terrestrial broadcast signals by analyzing headers of the received MPEG TSs.

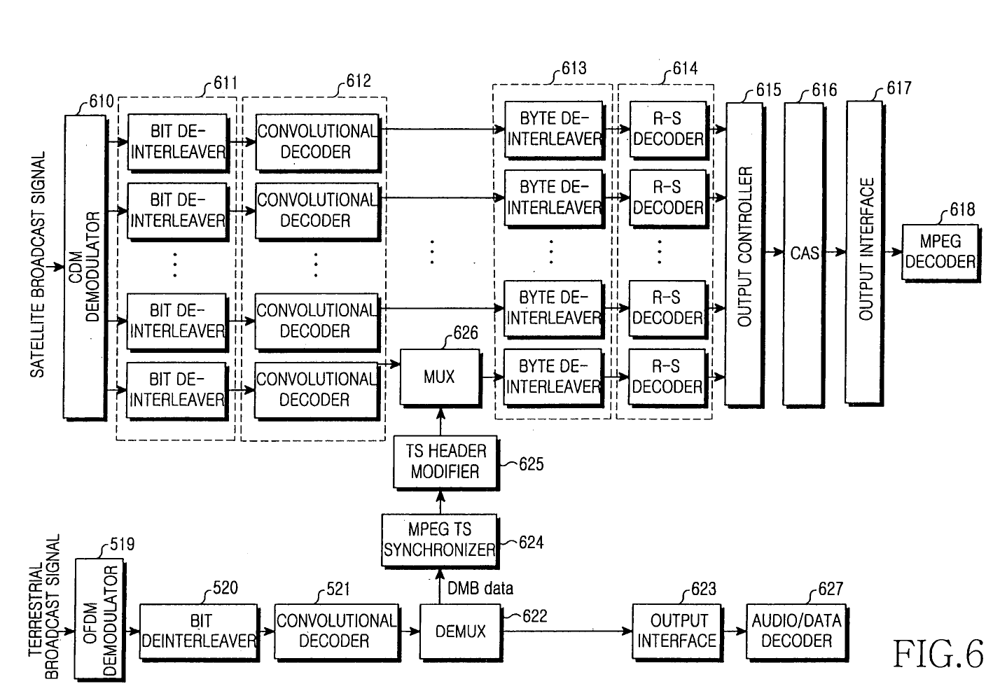

FIG. 6 is a block diagram illustrating a structure of a DMB reception apparatus according to further another embodiment of the present invention, wherein the DMB reception apparatus receives terrestrial broadcast signals using a predetermined channel of a satellite DMB modem instead of using the spare channels.

It is noted in FIG. 6 that a multiplexer 626 is not connected to all of the channel paths of a satellite DMB modem block, but connected only to a particular channel path used for receiving broadcast signals from a terrestrial DMB modem block. However, when there is a need to receive satellite broadcast signals through the particular channel of the satellite DMB modem, it is not possible to receive terrestrial broadcast signals. Therefore, the current embodiment receives the satellite broadcast signals through a spare channel of the satellite DMB modem, thereby simultaneously receiving the satellite broadcast signals and the terrestrial broadcast signals without data loss.

To this end, an output controller 615 is designed such that it can prevent an output of a particular channel designated as a spare channel and change a setting of preventing a channel output at a boundary of an input packet of an MPEG TS. In this manner, the embodiment can change a reception path of the satellite broadcast signals to be received through the particular channel to a spare channel. The output controller 615 prevents an output of the spare channel until the boundary of an input packet in order to prevent packet collision/loss for the satellite broadcast signals whose reception channel is changed.

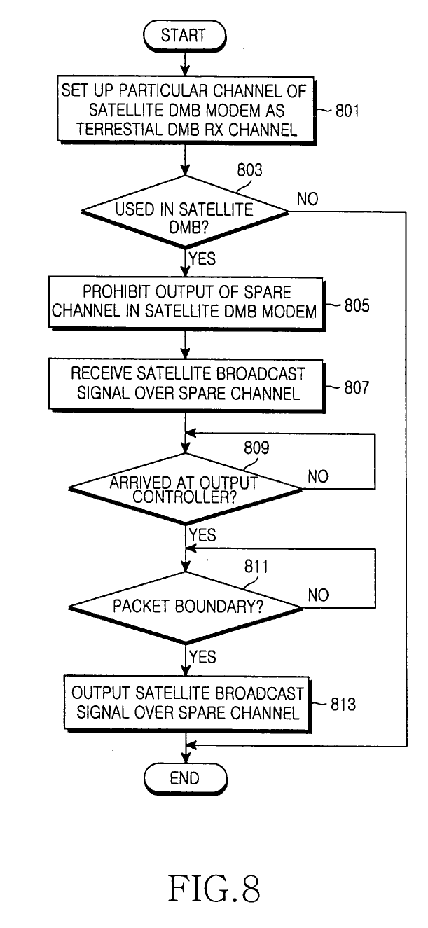

FIG. 8 is a flowchart illustrating a process of replacing a reception channel for satellite broadcast signals with a spare channel. With reference to FIG. 8, a detailed description of the embodiment of FIG. 6 will be given below.

In step 801, a controller of a mobile terminal designates a particular channel of a satellite DMB modem as a terrestrial DMB reception channel. It is assumed herein that terrestrial broadcast signals can be received only through the particular channel. If it is determined in step 803 that there is a need to receive satellite broadcast signals through the particular channel, the output controller 615 prevents output of a corresponding spare channel to prevent a data loss of the satellite broadcast signals in step 805. Thereafter, in step 807, the controller controls to the DMB reception apparatus to simultaneously receive the satellite broadcast signals bound for the particular channel through the spare channel. To this end, the controller allocates a Walsh code for the particular channel to the spare channel by controlling a CDM demodulator 610. The output controller 615 can be either included in the controller of the mobile terminal or separately provided. In this state, although output of terrestrial broadcasts on the spare channel is prohibited, the controller receives the satellite broadcast signals through the spare channel in step 807.

In step 809, the output controller 615 determines if a satellite broadcast signal has arrived. If the satellite broadcast signal has arrived at the output controller 615, the output controller 615 determines in step 811 whether the current time is a packet boundary of an MPEG TS for transmitting the satellite broadcast signal. If the current time is a packet boundary, the output controller 615 transmits the satellite broadcast signal through the spare channel in step 813, prohibiting transmission/reception of the satellite broadcast signal through the particular channel.

As can be understood from the foregoing description, to simultaneously receive satellite broadcast signals and terrestrial broadcast signals, the novel DMB reception apparatus is designed such that a satellite DMB modem and a terrestrial DMB modem share some elements rather than using entirely separate elements, thereby contributing a reduction in hardware complexity. Therefore, the DMB reception apparatus can separately decode MPEG TSs for the satellite broadcast signals and the terrestrial broadcast signals using a simple structure.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for receiving a multimedia broadcasting service in a mobile communication system including a satellite digital multimedia broadcasting (DMB) system and a terrestrial DMB system, the apparatus comprising:
a satellite DMB modem block for demodulating a satellite broadcast signal received from the satellite DMB system;
a terrestrial DMB modem block sharing at least one function block with the satellite DMB modem block, for demodulating a terrestrial broadcast signal received from the terrestrial DMB system; and
a Motion Picture Experts Group (MPEG) decoder for separately decoding MPEG transport streams (TSs) for the satellite broadcast signal and the terrestrial broadcast signal.

2. The apparatus of claim 1, wherein the satellite DMB modem block includes:
a deinterleaver for deinterleaving the satellite broadcast signal; and
a Reed-Solomon (R-S) decoder for error-correcting the deinterleaved satellite broadcast signal;
wherein the shared function block includes at least one of the deinterleaver and the R-S decoder.

3. The apparatus of claim 1, wherein the terrestrial broadcast signal is received through at least one spare channel of the satellite DMB modem block.

4. The apparatus of claim 1, wherein the terrestrial broadcast signal is received through at least one predetermined channel of the satellite DMB modem block.

5. The apparatus of claim 1, wherein the satellite DMB modem block includes at least one multiplexer for selectively outputting one of a reception channel for the satellite broadcast signal and a reception channel for the terrestrial broadcast signal.

6. The apparatus of claim 1, wherein the terrestrial broadcast signal is delivered to the MPEG decoder through the reception channel of the satellite DMB modem block.

7. The apparatus of claim 6, further comprising at least one or more header modifier for modifying a header of the terrestrial broadcast signal with a predetermined value being different from that of a header of the satellite broadcast signal, and delivering the header-modified terrestrial broadcast signal through the reception channel.

8. The apparatus of claim 7, further comprising a predetermined number of the header modifiers, when there is a plurality of channels for receiving of the terrestrial broadcast signal, the predetermined number of the header modifiers corresponds to the number of channels for receiving the terrestrial broadcast signal channels.

9. The apparatus of claim 4, further comprising control means for controlling the satellite DMB modem block to replace a reception channel for the satellite broadcast signal with a spare channel of the satellite DMB modem block, if it necessary is to receive the satellite broadcast signal through the particular channel.

10. The apparatus of claim 9, wherein the control means outputs the satellite broadcast signal through the spare channel after detecting a packet boundary of the satellite broadcast signal.

11. A method for receiving a multimedia broadcasting service in a mobile communication system including a satellite digital multimedia broadcasting (DMB) system and a terrestrial DMB system, the method comprising the steps of:
receiving a satellite broadcast signal of the satellite DMB system and a terrestrial broadcast signal of the terrestrial DMB system, from a wireless network;
modifying a header of a first Motion Picture Experts Group (MPEG) transport stream (TS) for the terrestrial broadcast signal with a predetermined value being different from that of a header of a second MPEG TS for the satellite broadcast signal; and
separately MPEG-decoding the first MPEG TS for the terrestrial broadcast signal and the second MPEG TS for the satellite broadcast signal.

12. The method of claim 11, wherein the terrestrial broadcast signal is received through at least one spare channel of a satellite DMB modem block in a receiver.

13. The method of claim 11, wherein the terrestrial broadcast signal is received through at least one predetermined channel of a satellite DMB modem block in a receiver.

14. The method of claim 11, wherein the terrestrial broadcast signal is delivered to a decoder for performing the MPEG decoding through a reception channel of a satellite DMB modem block in a receiver.

15. The method of claim 11, further comprising the step of byte-deinterleaving the terrestrial broadcast signal and the satellite broadcast signal at a satellite DMB modem block in a receiver.

16. The method of claim 15, further comprising the step of Reed-Solomon (R-S) decoding the terrestrial broadcast signal and the satellite broadcast signal at the satellite DMB modem block in the receiver.

17. The method of claim 13, further comprising the step of replacing the reception channel for the satellite broadcast signal with a spare channel of the satellite DMB modem block, if there it is necessary to receive the satellite broadcast signal through the particular channel.

18. The method of claim 17, further comprising the step of outputting the satellite broadcast signal through the spare channel after detecting a packet boundary of the satellite broadcast signal.
